(19) United States
(12) Patent Application Publication
(10) Pub. No.: US 2021/0165270 A1
(43) Pub. Date: Jun. 3, 2021

(54) REFLECTIVE PHOTONIC CRYSTAL COLOR FILM, DISPLAY DEVICE USING THE SAME AND FABRICATING METHOD THEREFOR

(71) Applicant: BOE TECHNOLOGY GROUP CO., LTD., Beijing (CN)

(72) Inventors: Xianqin MENG, Beijing (CN); Yafeng YANG, Beijing (CN); Jing LV, Beijing (CN); Xiaochuan CHEN, Beijing (CN); Wei WANG, Beijing (CN); Jifeng TAN, Beijing (CN); Xiandong MENG, Beijing (CN); Yunyun TIAN, Beijing (CN); Jian GAO, Beijing (CN)

(21) Appl. No.: 15/778,280

(22) PCT Filed: Sep. 22, 2017
(86) PCT No.: PCT/CN2017/102822

§ 371 Date: May 23, 2018

(30) Foreign Application Priority Data
Mar. 31, 2018 (CN) 201710207768.X

(51) Int. Cl. G02F 1/1335

(52) U.S. Cl. CPC G02F 1/133516; G02F 2202/32; G02F 1/133553

(57) ABSTRACT

In the disclosure there is provided a reflective photonic crystal color film, a display device using the same and a fabricating method therefor. The reflective photonic crystal color film includes a substrate and a two-dimensional photonic crystal structure formed on and periodically distributed over a surface of the substrate, wherein the two-dimensional photonic crystal structure comprises material containing silicon.

### CROSS REFERENCE

The present application claims the priority of Chinese Patent Application No. 201710207768.X and filed on Mar. 31, 2017, and the entire contents thereof are incorporated herein by reference as part of the present application.

### TECHNICAL FIELD

The present disclosure relates to the technical field of display, in particular to a reflective photonic crystal color film, a display device using the same and a fabricating method therefor.

### BACKGROUND

The gamut indicators of the currently internationally predominant three primary colors have already unable to meet the color saturation requirement in some high-end display fields, for example certain professional advertisements and high-definition screen. Accordingly, it is one of the most urgent needs in the display field to seek new methods to improve chromatic reality of screens. Although the gamut reproducibility based on the three-primary-color LED display devices has reached 120% of the standard gamut of NTSC. However, in the CIE standard gamut diagram, there is still area of approximate 40% outside the displaying region of the three-primary-color LED. How to enlarge the displaying range of the gamut is an important research direction to satisfy high-end demands.

Photonic crystals are artificial microstructures formed by periodic arrangement of dielectric of different refractive indices, and also called as artificial periodic dielectric structures featuring photonic band gap (PBG). PBG materials can modulate electromagnetic waves having corresponding wavelengths such that the photons having energy within the PBG are not allowed into the photonic crystals. Although “photonic crystal” is a new term, in the nature there already have been substances having this characteristic such as opals, butterfly wings, and insect eyes as shown in FIG. 1. I.e., lights of specular range of frequencies are prohibited to propagate in the photonic crystals, and are reflected into the human eyes. Accordingly, the human eyes can perceive the lights of those frequencies, i.e., the colors being able to be shown by opals, peacock feathers and butterfly wings.

It should be noted that the information disclosed in the above BACKGROUND section is only to enhance understanding of the background of the disclosure, and thus may contain information which is not part of the prior art known to those skilled in the art.

### SUMMARY

The disclosure has an objective to provide a reflective photonic crystal color film and a display device using the same.

Other features and advantages of the disclosure will be apparent from the following detailed description, or got partially from practice of the disclosure.

In one aspect of the disclosure, there is provided a reflective photonic crystal color film comprising:

a substrate; and

a two-dimensional photonic crystal structure formed on and periodically distributed over a surface of the substrate, wherein the two-dimensional photonic crystal structure comprises material containing silicon.

In an exemplary embodiment of the disclosure, the two-dimensional photonic crystal structure is of a column or hole structure.

In an exemplary embodiment of the disclosure, the two-dimensional photonic crystal structure is of a circular column structure or cube structure.

In an exemplary embodiment of the disclosure, the two-dimensional photonic crystal structure is of a circular hole structure or square hole structure.

In an exemplary embodiment of the disclosure, the two-dimensional photonic crystal structure is of a circular column structure, and has a period of 330-450 nm and a duty ratio of 20-30%, wherein the circular column has a height of 110-130 nm and a diameter of 190-210 nm.

In an exemplary embodiment of the disclosure, the two-dimensional photonic crystal structure is of a circular hole structure, and has a period of 240-280 nm and a duty ratio of 20-30%, wherein the circular hole has a depth of 110-130 nm and a diameter of 125-145 nm.

In an exemplary embodiment of the disclosure, the two-dimensional photonic crystal structure is of a circular hole structure, and has a period of 120-200 nm and a duty ratio of 20-30%, wherein the circular hole has a depth of 90-110 nm and a diameter of 90-110 nm.

In an exemplary embodiment of the disclosure, the two-dimensional photonic crystal structure is of a circular column structure, and has a period of 210-230 nm and a duty ratio of 20-30%, wherein the circular column has a height of 90-110 nm and a diameter of 110-130 nm.

In an exemplary embodiment of the disclosure, the two-dimensional photonic crystal structure has a period of 220 nm, the circular column has a height of 100 nm and a diameter of 124 nm.

In an exemplary embodiment of the disclosure, the two-dimensional photonic crystal structure is of a circular column structure, and has a period of 290-320 nm and a duty ratio of 20-30%, wherein the circular column has a height of 110-130 nm and a diameter of 160-180 nm.

In an exemplary embodiment of the disclosure, the two-dimensional photonic crystal structure has a period of 300 nm, the circular column has a height of 120 nm and a diameter of 170 nm.

In a second aspect of the disclosure, there is provided a fabricating method for reflective photonic crystal color film comprising:

forming a substrate;

forming on the substrate a film of material containing silicon; and

obtaining a two-dimensional photonic crystal structure periodically distributed on a surface of the substrate by exposing and etching the film.

In an exemplary embodiment of the disclosure, the two-dimensional photonic crystal structure is of column or hole structure.

In a third aspect of the disclosure, there is provided a display device comprising a reflective photonic crystal color film according to the first aspect of the disclosure, a liquid crystal formed on the reflective photonic crystal color film, and a front light source formed on the liquid crystal.

In a fourth aspect of the disclosure, there is provided a fabricating method for display device comprising:

forming a reflective photonic crystal color film according to the first aspect of the disclosure;

forming a liquid crystal on the reflective photonic crystal color film; and

forming a front light source on the liquid crystal.

It should be appreciated that the foregoing general description and the following detailed description are both exemplary and illustrative, and not to limit the disclosure.

The outline presented in this section for various implementations or examples of the techniques described in the disclosure is not a complete disclosure for the full scope or all technical features of the disclosed techniques.

### BRIEF DESCRIPTION OF THE DRAWINGS

The aforesaid and other objects, features and advantages of the disclosure will become more apparent by detailed description of exemplary embodiments thereof with reference to the accompanying drawings.

The figures herein which are incorporated into and constitute part of the specification show embodiments in compliance with the disclosure, and are intended to explain the principal of the disclosure with the specification. Obviously, the figures described below involve only some of the embodiments of the disclosure. Those skilled in the art will get other figures from these figures without creative efforts.

FIG. 1 shows schematic views of photonic crystals existing in nature.

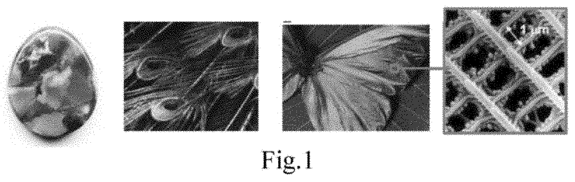

FIG. 2 shows a side view of a reflective photonic crystal color film according to an exemplary embodiment of the disclosure.

FIG. 3 shows a top view of a reflective photonic crystal color film according to an exemplary embodiment of the disclosure.

FIG. 4 shows a diagram of refractive coefficient and extinction coefficient of silicon-based material used in a reflective photonic crystal color film according to an exemplary embodiment of the disclosure.

FIG. 5 shows a spectrum diagram of generating red by a reflective photonic crystal color film according to an exemplary embodiment of the disclosure.

FIG. 6 shows a spectrum diagram of generating green by a reflective photonic crystal color film according to an exemplary embodiment of the disclosure.

FIG. 7 shows a spectrum diagram of generating blue by a reflective photonic crystal color film according to an exemplary embodiment of the disclosure.

FIG. 8 shows a spectrum diagram of generating cyan by a reflective photonic crystal color film according to an exemplary embodiment of the disclosure.

FIG. 9 shows a spectrum diagram of generating yellow by a reflective photonic crystal color film according to an exemplary embodiment of the disclosure.

FIG. 10 shows a side view and a top view of another reflective photonic crystal color film according to an exemplary embodiment of the disclosure.

FIG. 11 shows a schematic view of a display device using a reflective photonic crystal color film according to an exemplary embodiment of the disclosure.

### DETAILED DESCRIPTION

Now fuller description will be made to the exemplary embodiments with reference to the figures. However, the exemplary embodiments can be implemented variously and shall not be interpreted to limit the examples set forth herein. The described features, structures or performances may be combined in one or more embodiments in any appropriate way. In the following description many details are provided to give a full understanding of the embodiments of the disclosure. However, those skilled in the art will realize that the technical solutions of the disclosure may be practiced omitting one or more of the particular details, or employ other methods, elements, devices and steps and the like.

It should be noted that in figures the sizes for layers and areas may be exaggerated for clarity of illustration. It should be understood that when an element or layer is referred to as being “on” another element or layer, it may be directly on the another element, or there may be an intermediate layer. In addition, it should be understood that when an element or layer is referred to as being “under” another element or layer, it may be directly under the another element, or there may be one or more intermediate layers or elements. In addition, it should also be understood that when an element or layer is referred to as being “between” two elements or layers, it may be the single one layer therebetween, or there may be one or more intermediate layers or elements. Like references indicate like elements through the specification.

In the disclosure there is provided a reflective photonic crystal color film and a display device using the same. The reflective photonic crystal color film comprises a substrate and a two-dimensional photonic crystal structure formed on and periodically distributed over a surface of the substrate, wherein the two-dimensional photonic crystal structure comprises material containing silicon. With designs to adjust a geometric parameter(s) and film thickness of a two-dimensional photonic crystal structure of material containing silicon, reflection of only red, green, blue, cyan and yellow, the five RGBCY colors, will be accomplished. The photonic crystal color film of the disclosure can not only replace the conventional color film substrates, but also expand the color gamut, generate a cyan and yellow supplementary exited lights which are difficult to be generated by the conventional color films, and can also generate the five RGBCY colors in conjunction with a color film of the three GRB primary colors, reproduce natural colors, and thus obtain a more lifelike display picture. At the same time, by optimizing the geometric parameters of the two-dimensional photonic crystal structure, RGB corresponds to a spectrum with a narrower width than the conventional color films, and a relatively high color saturation is realized, whereby a vivid picture as displayed is obtained.

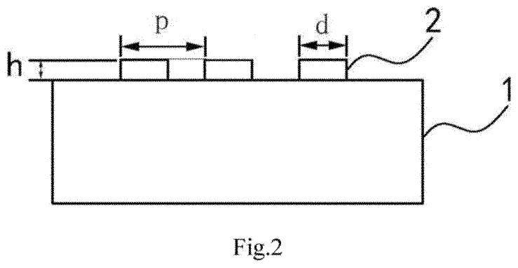

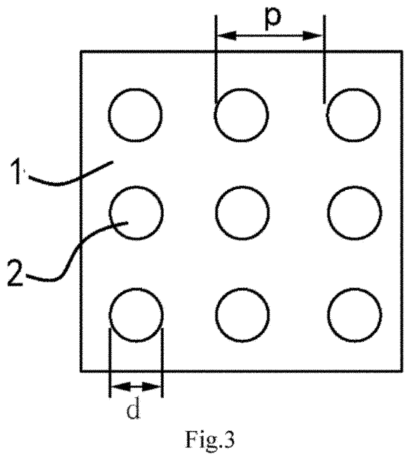

Now detailed description will be made to the reflective photonic crystal color film of the disclosure in conjunction with the accompanying drawings, in which FIG. 2 shows a side view of a reflective photonic crystal color film according to an embodiment of the disclosure, and FIG. 3 shows a top view of a reflective photonic crystal color film according to an embodiment of the disclosure.

As shown in FIG. 2, the reflective photonic crystal color film comprises a substrate 1 and a two-dimensional photonic crystal structure 2 formed on and periodically distributed over a surface of the substrate 1, wherein the two-dimensional photonic crystal structure 2 comprises material containing silicon.

Here, the substrate 1 may be, not is not limited to, a glass substrate, and may alternatively comprise another transparent inorganic material or transparent organic material.

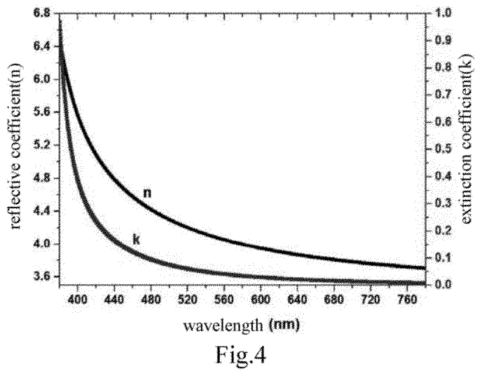

The two-dimensional photonic crystal structure 2 is obtained by exposing and etching a silicon-based film formed on the substrate 1. The refractive coefficient n and the extinction coefficient k are illustrated in FIG. 4. In the disclosure, the silicon-based film has a thickness between 90 nm and 130 nm, preferably, between 100 nm and 120 nm, for a purpose that the material of the silicon-based film has a low absorption and a high reflection within the visible light band. The thickness of the silicon-based film varies slightly with the color of the exited light as required. The two-dimensional photonic crystal structure is obtained by exposure and etching on the silicon-based film. Here, the material of the silicon-based film may alternatively be replaced with another material to accomplish the reflective or transmitting photonic crystal color film with, however, the parameters being optimally redesigned, descriptions for which are not repeated here. In addition, the surface of the silicon-based film is required to have a good flatness, i.e., small surface roughness, in order to reduce the influence on the wavelength and intensity of the exited light.

The two-dimensional photonic crystal structure 2 is of column or hole structure. The column structure as described in the disclosure is a column structure formed by removing portions other than columns of the silicon-based film via exposure and etching and leaving the columns spaced from each other on the surface of the substrate with a periodical distribution, as shown in FIG. 2 or 3. The column structure is of circular column or cube structure, i.e., the column structure has a cross-section in shape of circle or square. To the contrary, however, the hole structure, not shown, as described in the disclosure is a hole structure with holes formed by exposure and etching in the silicon-based film and having a periodic distribution over a plane of the silicon-based film, i.e., a plane parallel to the substrate 1. The hole structure is of circular hole or square hole, i.e., the hole structure has a cross-section in shape of circle or square.

The period p, the column height/hole depth h, the diameter of the circular column/circular hole d, and the width of the cube/square hole l, as well as the duty ratio, are determined by the color of the exited light as designed. The forbidden band of the photonic crystal with particular parameters may not allow a light of particular wavelength to pass through the photonic crystal but be reflected directly, thereby generating an exited light of particular color. Although the disclosure only provides a detailed description to the reflective photonic crystal color film, the purpose may alternatively be accomplished by design of a reflective or transmitting photonic crystal color film by selecting material, and using a photonic crystal having another shape such as two-dimensional nanometric holes and nanometric cubes, and even one-dimensional nanometric lines or grooves.

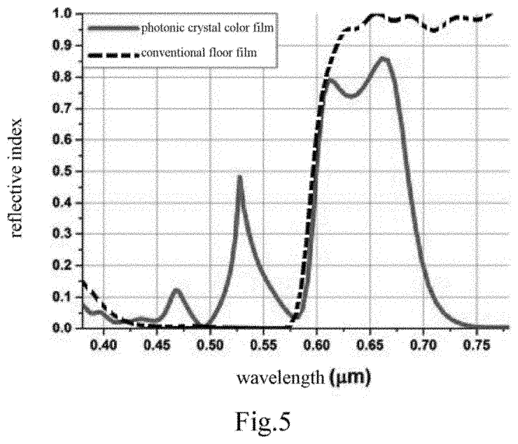

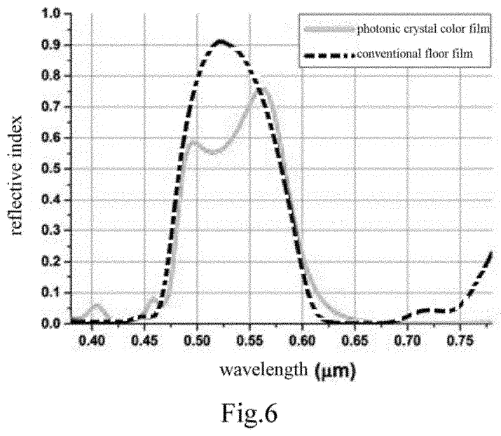

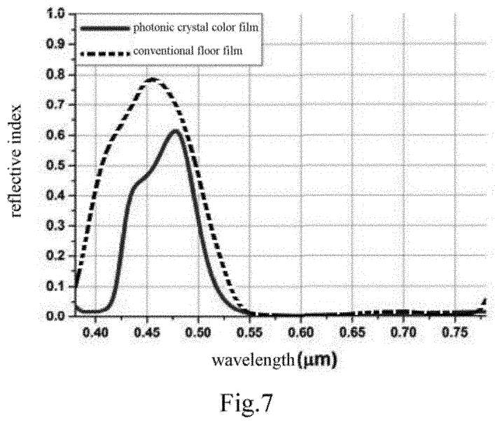

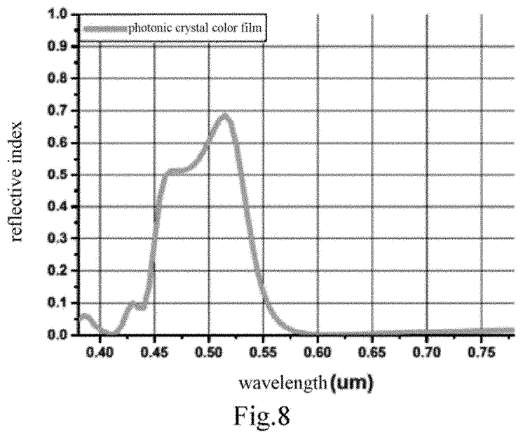

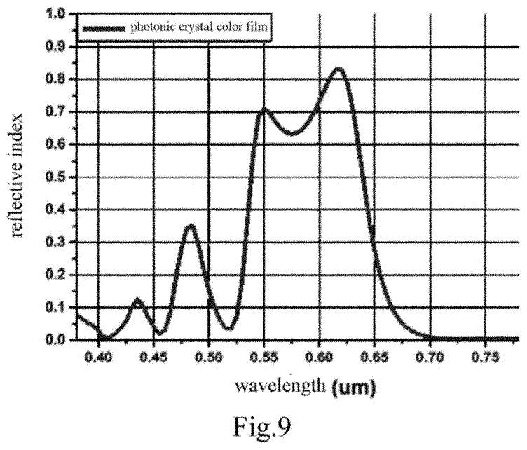

Now generation of red, green, blue, cyan and yellow, the five RGBCY colors, by the reflective photonic crystal color film of the disclosure will be described in detail in conjunction with FIGS. 5-9, of which FIG. 5 shows a spectrum diagram of generating red by a reflective photonic crystal color film according to an exemplary embodiment of the disclosure, FIG. 6 shows a spectrum diagram of generating green by a reflective photonic crystal color film according to an exemplary embodiment of the disclosure, FIG. 7 shows a spectrum diagram of generating blue by a reflective photonic crystal color film according to an exemplary embodiment of the disclosure, FIG. 8 shows a spectrum diagram of generating cyan by a reflective photonic crystal color film according to an exemplary embodiment of the disclosure, and FIG. 9 shows a spectrum diagram of generating yellow by a reflective photonic crystal color film according to an exemplary embodiment of the disclosure.

A way to generate red. On the silicon-based film with thickness of 120 nm is designed a two-dimensional circular column-shaped photonic crystal structure as shown in FIGS. 2-3. If the two-dimensional structure has nanometric structural geometric parameters: the period is 330-450 nm, the duty ratio of two-dimensional circular columns is about 20-30%, preferably 25%, the column height is 110-130 nm, preferably 120 nm, i.e., the silicon layer is etched through, and the diameter of two-dimensional circular columns is 190-210 nm, then it may be obtained that an incident light of 600-780 nm is reflected. Optimizing the geometric parameters of the two-dimensional periodic nanometric structure such that the period is 350 nm and the diameter of two-dimensional circular columns is 198 nm will result in a red exited light in range of 600-700 nm. It can be seen from FIG. 5 which shows a spectrum diagram of generating red by a reflective photonic crystal color film according to an exemplary embodiment of the disclosure that the obtained red photonic crystal color film has a full width at half maximum (FWHM) significantly less than that of the conventional color films, and has a relatively high red saturation.

A way to generate green. A two-dimensional photonic crystal structure for generating green is of circular hole structure. Similarly, a silicon-based two-dimensional hole-shaped photonic crystal may also reflect an incident light within the range of green in the spectrum as an exited light by adjusting relevant parameters of the photonic crystal. The parameters of the photonic crystal for an exited light within the range of green in the spectrum are: the period is 240-280 nm, the duty ratio of two-dimensional holes is about 20-30%, preferably 25%, the depth of the circular holes is 110-130 nm, preferably 120 nm, and the diameter of two-dimensional circular holes is 125-145 nm. Then green is obtained to emit within the range of 500-600 nm. By optimizing the geometric parameters of the green filter such that the period is 240 nm and the diameter of two-dimensional circular holes is 135 nm, a green photonic crystal color film will be obtained with a chromaticity of the same FWHM as the conventional color films, as shown in FIG. 6.

A way to generate blue. A two-dimensional photonic crystal structure for generating blue is also of circular hole structure. Being same as the above, the parameters of the photonic crystal for an exited light within the range of blue in the spectrum are: the period is 120-200 nm, the duty ratio of two-dimensional holes is about 20-30%, preferably 25%, the depth of the circular holes is 90-110 nm, preferably 100 nm, and the diameter of two-dimensional circular holes is 90-110 nm. Then a blue light within the range of 380-500 nm is reflected and a blue is generated. By optimizing the geometric parameters of the blue filter such that the period is 180 nm and the diameter of two-dimensional circular holes is 102 nm, a blue photonic crystal color film will be obtained with a FWHM narrower than that of the conventional color films (as shown in FIG. 7), a relatively high color saturation, and relatively vivid blue.

A way to generate cyan. A two-dimensional photonic crystal structure for generating cyan is of circular column structure. If the two-dimensional photonic crystal structure has a period between 120 and 200 nm, a thickness of the silicon-based film of 90-110 nm, preferably 100 nm, a duty ratio of about 20-30%, preferably 25%, a diameter of the circular columns of 110-130 nm, then a cyan exited light of 450-550 nm or so will be obtained. When optimizing the parameters such that the period is 220 nm, the diameter of the circular column-shaped silicon is 124 nm, and etching through the silicon film with a thickness of 100 nm, an incident light of 505±50 nm may be partially reflected back to the system by the photon forbidden band of the two-dimensional photonic crystal, thereby obtaining a cyan exited light with a FWHM of 100 nm or so, as shown in FIG. 8.

A way to generate yellow. A two-dimensional photonic crystal structure for generating yellow is also of circular column structure. Similarly, an incident light within the range of yellow in the spectrum will be reflected as an exited light by adjusting relevant parameters of the photonic crystal. The parameters of the photonic crystal for an exited light within the range of blue in the spectrum are: the period is 290-320 nm, the duty ratio is 20-30%, preferably 25%, the thickness of the silicon film is 110-130 nm, preferably 120 nm, and the diameter of circular column structure is 160-180 nm. Then a yellow exited light is generated. By optimizing the parameters for a yellow exited light to obtain the following geometric parameters of the two-dimensional structure with a FWHM of about 100 nm: the period is 300 nm and the diameter of silicon circular columns is 170 nm, and etched through the silicon film with a thickness of 120 nm, a yellow light within the range of 580±50 nm will be obtained, as shown in FIG. 9.

As known from the above, the disclosure utilizes a two-dimensional photonic crystal structure of material containing silicon to generate supplementary colors of cyan and yellow, and in combination with the existing three RGB primary colors, generate a display of the five RGBCY colors, expanding the color gamut and accomplishing a display with high saturation and color gamut.

In addition, in order to further improve reflective efficiency, a structure may be added at the bottom of the substrate such that part of the transmitted light is again reflected back into the photonic crystal structure, thereby accomplishing the purpose of increasing reflective efficiency. Alternatively, a reflective micronanometric structure may be designed on the substrate to diffract the transmitted light through the photonic crystal back into the photonic crystal, thereby increasing reflective efficiency. However, the disclosure is not limited to the two designs.

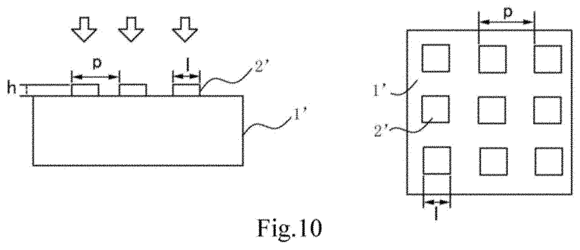

In addition to the two-dimensional circular column-shaped photonic crystal structure used to generate cyan and yellow, a two-dimensional cube-shaped photonic crystal structure, i.e., a photonic crystal structure having a square-shaped cross-section, may be used to generate cyan and yellow. Now a detailed description will be made with reference to FIG. 10.

FIG. 10 shows a side view and a top view of another reflective photonic crystal color film according to an exemplary embodiment of the disclosure. As shown in FIG. 10, the reflective photonic crystal color film comprises a substrate 1′, and a two-dimensional cube-shaped photonic crystal structure 2′, i.e., a photonic crystal structure having a square-shaped cross-section, formed on and periodically distributed over a surface of the substrate 1′. Hereinafter, ways to generate cyan and yellow by the two-dimensional cube-shaped photonic crystal structure will be described in detail, respectively.

A way to generate cyan. According to an exemplary embodiment of the disclosure, a two-dimensional cube-shaped photonic crystal structure is designed on a silicon-based film with a thickness of 100 nm, as shown in FIG. 10, having parameters as follows: the period is 220 nm, the side, i.e., the width of the two-dimensional cube-shaped photonic crystal is 110 nm. The silicon-based film with a thickness of 100 nm is etched through. Then an incident light of 505±50 nm may be partially reflected back to the system by the photon forbidden band of the two-dimensional photonic crystal, thereby obtaining a cyan exited light.

A way to generate yellow. According to an exemplary embodiment of the disclosure, the silicon-based two-dimensional cube-shaped photonic crystal may also reflect an incident light within the range of yellow in the spectrum as an exited light by adjustment of relevant parameters of the photonic crystal. The parameters of the photonic crystal for an exited light with the range of yellow in the spectrum are: the period is 300 nm, the side of the two-dimensional cube-shaped structure is 150 nm. The silicon film with a thickness of 120 nm is etched through. Then a yellow light within the range of 580±50 nm may be obtained.

In addition, in the disclosure there is provided a fabricating method for reflective photonic crystal color film comprising: forming a substrate; forming on the substrate a film of material containing silicon; and obtaining a two-dimensional photonic crystal structure periodically distributed on a surface of the substrate by exposing and etching the film.

In an exemplary embodiment of the disclosure, the two-dimensional photonic crystal structure is of column or hole structure.

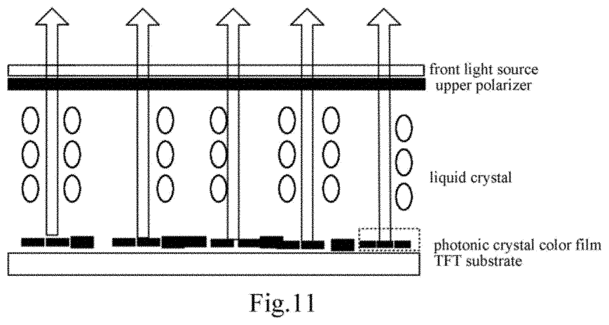

FIG. 11 shows a schematic view of a display device using a reflective photonic crystal color film according to an exemplary embodiment of the disclosure.

As shown in FIG. 11, the display device using a reflective photonic crystal color film comprises a reflective photonic crystal color film according to the foregoing description of the disclosure, a liquid crystal formed on the reflective photonic crystal color film, and a front light source formed on the liquid crystal. The display device may further comprise a TFT substrate formed under the reflective photonic crystal color film, and an upper polarizer formed between the liquid crystal and the front light source, to which the disclosure is not limited.

Here, the front light source allows a collimated plane light to be incident from up to down. The collimated light source may be formed by semiconductor laser chips of five colors of R, B, C and Y with the lights being blended, or by LED chips having good collimation of five colors of R, B, C and Y with the lights being blended, or by a LED chip of white light having good collimation, or by a strip-shaped CCFL fluorescent tube in combination with light collimating structures. The disclosure is not limited to these types.

The upper polarizer may be selected from, but is not limited to, iodine family polarizers with high transmitting ratio and polarization. The polarizer may be further processed depending on the particular requirements in a practical application such as displayers for notebook computers or displayers for TVs. The study for polarizers is not focused on by the study of the disclosure, and detailed descriptions are not made for them here.

The material for liquid crystal may be selected from, but is not limited to, the liquid crystal materials applicable for products of display mode of ADS (IPS or FFS) and products of display mode of VA, and may also use the liquid crystal material of blue phase. There is not a special requirement on thickness of the liquid crystal which may be adjusted depending on a practical application.

The TFT substation, of which TFT belongs to an active matrix liquid crystal display, is formed by, but is not limited to, depositing a layer of film on a substrate such as a glass substrate or a substrate of specific resin material. Arrays are microfabricated on the film substrate as driving channel areas each for a liquid crystal pixel.

It should be particularly noted here that the exemplary embodiment is only an example of the reflective photonic crystal color film being applied to liquid crystal display with high resolution. However, the disclosure is not limited thereto. The reflective photonic crystal color film of the disclosure may also be applied to the fields of color separation, OLED display, color LED and other relevant high-end color display.

In addition, in the disclosure there also is provided a fabricating method for display device comprising: forming a reflective photonic crystal color film according to the foregoing description of the disclosure; forming a liquid crystal on the reflective photonic crystal color film; and forming a front light source on the liquid crystal.

To sum up, according to some embodiments of the disclosure, with designs to adjust a geometric parameter(s) and film thickness of a two-dimensional photonic crystal structure of material containing silicon, reflection of only red, green, blue, cyan and yellow, the five RGBCY colors, will be accomplished. The photonic crystal color film of the disclosure can not only replace the conventional color film substrates, but also expand the color gamut, generate a cyan and yellow supplementary exited lights which are difficult to be generated by the conventional color films, and can also generate the five RGBCY colors in conjunction with a color film of the three GRB primary colors, reproduce natural colors, and thus obtain a more lifelike display picture.

According to some embodiments of the disclosure, by optimizing the geometric parameters of the two-dimensional photonic crystal structure of material containing silicon, RGB corresponds to a spectrum with a narrower width than the conventional color films, and a relatively high color saturation is realized, whereby a vivid picture as displayed is obtained.

Those skilled in the art, after considering the specification and practicing the disclosure disclosed here, will readily envisage other embodiments of the disclosure. The present application is intended to encompass any variation, usage or adaptive alteration which follows the general principle of the disclosure and comprise the common knowledge or customary technical means in the art not disclosed by the disclosure. The specification and the embodiments shall be interpreted only as exemplary. The true spirit and scope of the disclosure are pointed out by the appended claims.

It should be appreciated that the disclosure is not limited to the exact structure described above and illustrated in the figures, and can be made with various modifications and changes without departure of the scope of the disclosure. The scope of the disclosure is only defined by the appended claims.

1. A reflective photonic crystal color film comprising:
a substrate; and
a two-dimensional photonic crystal structure, formed on and periodically distributed over a surface of the substrate, wherein the two-dimensional photonic crystal structure comprises material containing silicon.

2. The reflective photonic crystal color film according to claim 1, wherein the two-dimensional photonic crystal structure is of a column or hole structure.

3. The reflective photonic crystal color film according to claim 2, wherein the two-dimensional photonic crystal structure is of a circular column structure or cube structure.

4. The reflective photonic crystal color film according to claim 2, wherein the two-dimensional photonic crystal structure is of a circular hole structure or square hole structure.

5. The reflective photonic crystal color film according to claim 3, wherein the two-dimensional photonic crystal structure is of a circular column structure, and has a period of 330-450 nm and a duty ratio of 20-30%, wherein the circular column has a height of 110-130 nm and a diameter of 190-210 nm.

6. The reflective photonic crystal color film according to claim 4, wherein the two-dimensional photonic crystal structure is of a circular hole structure, and has a period of 240-280 nm and a duty ratio of 20-30%, wherein the circular hole has a depth of 110-130 nm and a diameter of 125-145 nm.

7. The reflective photonic crystal color film according to claim 4, wherein the two-dimensional photonic crystal structure is of a circular hole structure, and has a period of 120-200 nm and a duty ratio of 20-30%, wherein the circular hole has a depth of 90-110 nm and a diameter of 90-110 nm.

8. The reflective photonic crystal color film according to claim 3, wherein the two-dimensional photonic crystal structure is of a circular column structure, and has a period of 210-230 nm and a duty ratio of 20-30%, wherein the circular column has a height of 90-110 nm and a diameter of 110-130 nm.

9. The reflective photonic crystal color film according to claim 8, wherein the two-dimensional photonic crystal structure has a period of 220 nm, the circular column has a height of 100 nm and a diameter of 124 nm.

10. The reflective photonic crystal color film according to claim 3, wherein the two-dimensional photonic crystal structure is of a circular column structure, and has a period of 290-320 nm and a duty ratio of 20-30%, wherein the circular column has a height of 110-130 nm and a diameter of 160-180 nm.

11. The reflective photonic crystal color film according to claim 10, wherein the two-dimensional photonic crystal structure has a period of 300 nm, the circular column has a height of 120 nm and a diameter of 170 nm.

12. A fabricating method for reflective photonic crystal color film comprising:
forming a substrate;
forming on the substrate a film of material containing silicon; and obtaining a two-dimensional photonic crystal structure periodically distributed on a surface of the substrate by exposing and etching the film.

13. The fabricating method for reflective photonic crystal color film according to claim 12, wherein the two-dimensional photonic crystal structure is of a column or hole structure.

14. A display device comprising a reflective photonic crystal color film according to claim 1, a liquid crystal formed on the reflective photonic crystal color film, and a front light source formed on the liquid crystal.

15. A fabricating method for display device comprising:
forming a reflective photonic crystal color film according to claim 1;
forming a liquid crystal on the reflective photonic crystal color film; and
forming a front light source on the liquid crystal.

16. The fabricating method for reflective photonic crystal color film according to claim 13, wherein the two-dimensional photonic crystal structure is of a circular column structure or cube structure.

17. The fabricating method for reflective photonic crystal color film according to claim 13, wherein the two-dimensional photonic crystal structure is of a circular hole structure or square hole structure.
